(19) United States
(12) Patent Application Publication
(10) Pub. No.: US 2009/0223672 A1
(43) Pub. Date: Sep. 10, 2009

(54) APPARATUS AND METHOD FOR A HYDROCARBON PRODUCTION FACILITY

(75) Inventor: Hemant Naik, Aberdeen (GB)

Correspondence Address: PEPPER HAMILTON LLP, ONE MELLON CENTER, 50TH FLOOR, 500 GRANT STREET, PITTSBURGH, PA, 15219, US

(73) Assignee: UPSTREAM DESIGNS LIMITED, Aberdeen (GB)

(21) Appl. No.: 12/297,566

(22) PCT Filed: Mar. 19, 2007
(86) PCT No.: PCT/GB07/00974

§ 371 Date: Oct. 17, 2008

(30) Foreign Application Priority Data
Apr. 18, 2006 (GB) 0607648.3
Apr. 19, 2006 (GB) 0607689.7
Feb. 23, 2007 (GB) 0703571.0

(51) Int. Cl. E21B 29/12; B08B 9/04

(52) U.S. Cl. 166/344; 134/8

(57) ABSTRACT

The present application concerns apparatus for a hydrocarbon production facility, and a method of launching a pig into a pipeline. The apparatus may include export riser that provides a first flow path for production fluid from a production well, a pig launcher for launching a pig into the export riser at a first location, together with bypass tubing providing a second flow path for the production fluid which bypasses the export riser at the first location. This may allow production fluid to continue to flow from a production well through the export riser even when a pig or pig train is being located in the export riser.

### CROSS-REFERENCE TO RELATED APPLICATIONS

This Application claims the priority benefit of International Patent Application PCT/GB2007/000974 with an International Filing Date of Mar. 19, 2007 with subsequent publication as International Publication Number WO 2007/119040 on Oct. 25, 2007. PCT/GB2007/000974, in turn, claims priority to Great Britain Patent Application No. 0703571.0, filed Feb. 23, 2007, Great Britain Patent Application No. 0607689.7 filed Apr. 19, 2006 and Great Britain Patent Application No. 0607648.3, filed Apr. 18, 2006. The disclosures of each of the aforementioned patent documents are incorporated herein by reference in their entirety.

NOT APPLICABLE

### BACKGROUND

The present invention relates to apparatus for a hydrocarbon production facility for assisting with the export of hydrocarbons through a transportation pipeline. In one of its aspects, the present invention relates to a method for launching a pipeline inspection gauge (pig) into a pipeline.

Oil and gas produced from sub-surface wells typically need to be transported from a well production facility, such as a production rig or platform, through a pipeline to another location for treatment and processing. Often there is a significant distance between the production facility near the well and the treatment plant. For example, in the case of an offshore production rig, hydrocarbons are often transported to a refinery or a treatment plant onshore.

The hydrocarbon fluids carried in these pipelines, which are typically constructed from carbon steel, can be highly corrosive and may cause pipelines to degrade over time, resulting in significant maintenance costs and loss of production.

To avoid corrosive degradation of the pipeline, it is known to treat the production fluid itself to prevent it from causing corrosion before the fluid is transported to shore. However, this typically needs complex processing equipment and chemical storage facilities to be installed on the production rig, which is undesirable due to lack of available space. It can also be expensive to maintain equipment, in particular where production rigs exist in remote locations that are difficult to access. Also, many well production rigs are unmanned and lack the necessary infrastructure to accommodate such complex equipment.

As an alternative, it is known to construct pipelines from non-corrosive alloys. However, where pipelines extend significant distances, such as from a production facility to shore, it may be prohibitively expensive to construct pipelines from such materials.

Pipeline pigging operations are carried out to treat the pipeline by locating in it one or more pigs which can travel along the pipeline to deliver corrosion inhibiting fluid. These pigs are propelled by the produced fluids.

There are however a number of drawbacks associated with such pigging operations. Multiple pigs may be prepared and launched into a pipeline as a pig train, allowing multiple, separated volumes of fluids to be used to treat the pipeline. However, such pig trains extend over significant distances. One approach is to provide a large pig launcher to accommodate the entire pig train during preparation and injection of treatment fluids. However, in many facilities sufficient space and infrastructure is not available for such a pig launcher. This requires preparation and launch of multiple pigs over a period of time to create the pig train. During this period, production from the wells may need to be interrupted. This downtime in production is costly; interruptions can also be detrimental to the normal processes of the facility and may necessitate an increase in manual intervention. Attempts to minimize downtime by accelerating the process of preparing and launching multiple pigs are faced with further difficulties, for example, the capital expenditure, space requirements, power supply and safety issues associated with high flow rate injection pumps for treatment fluid.

It is an aim of the present invention to obviate or at least mitigate the problems and drawbacks associated with conventional apparatus and methods.

Further aims and objects will become apparent from the description below.

### SUMMARY

According to a first aspect of the invention, there is provided apparatus for a hydrocarbon production facility, the apparatus comprising: export tubing providing a first flow path for production fluid from a production well; a pig launcher for launching a pig into the export tubing at a first location; and bypass tubing providing a second flow path for the production fluid which bypasses the export tubing at the first location.

Thus, the apparatus may permit production fluid to continue to flow from a production well through the export tubing even when a pig or pig train is being located in the export tubing.

Preferably, the bypass tubing defines a bypassed length of the export tubing, wherein the bypassed length extends to include the first location. The bypassed length may extend over a distance sufficient to accommodate a volume of treatment fluid located in the export tubing.

Preferably, the bypassed length is adapted to receive a pig train comprising a plurality of pigs. The bypassed length may extend a distance sufficient to receive a pig train equipped for treating a long-distance pipeline, e.g., with batches of treatment fluid such as corrosion inhibitor fluid.

The pig launcher may be installed at the production facility. The bypassed length of the export tubing may extend substantially between the production facility and a transport pipeline.

Preferably, the apparatus forms a part of a rig and/or platform, such as a wellhead platform, which may be located offshore or onshore. The facility may be located remotely from a plant for treating the production fluid. Preferably, the hydrocarbon production facility is a minimum equipment/footprint facility. The facility is preferably adapted to use space efficiently. The production facility may be an unmanned facility.

The export tubing may comprise a pipeline for transport of production fluid to a remote treatment plant. The export tubing may comprise a first export riser, which may connect an end of the transport pipeline with the hydrocarbon production facility. The first export riser may comprise a first end coupled to the facility and a second end coupled to the transport pipeline for passage of fluid from the production well into and through the pipeline.

The bypass tubing may comprise a second export riser. In embodiments where the export tubing comprises an export riser connecting a pipeline with the production facility, the bypass tubing may comprise a second export riser for the flow of fluid from the production well and into the transport pipeline.

The bypass tubing may comprise a first end fluidly connected to the export tubing upstream of the pig launcher, and a second end fluidly connected to the main tubing downstream of the pig launcher.

The bypass tubing may be formed from a corrosion resistant material. The corrosion resistant material may comprise a metal alloy, and/or a synthetic composite material. Advantageously therefore, this limits or eliminates the requirement to apply corrosion inhibitor chemicals to the production fluid to prevent corrosion of the bypass tubing.

The pig launcher may comprise an access port for locating a pig in the launcher. The pig launcher may be adapted to facilitate automatic and/or manual launch of pigs into the export tubing.

Preferably, the pig or pig train is adapted to carry corrosion inhibitor fluid for transport in the export tubing. Thus, corrosion of the export tubing can be reduced or prevented. The pig may be adapted to deliver corrosion inhibitor at pre-determined locations in the export tubing. The pig may comprise pipeline cleaning apparatus, which may comprise, for example, scraping or wiping members and/or jetting tools.

The pig launcher may be adapted to allow successive launch of a plurality of pigs to form a pig train in the export tubing. The pig train may thus comprise a plurality of pigs coupled to each other for transport through the tubing. The pig launcher may be adapted to temporarily house at least one pig before location in the export tubing. The pig launcher may be sized to house a limited sub-set of the plurality of pigs forming the pig train at any one time. Preferably, the pig launcher is sized to a minimum configuration in which one pig is temporarily accommodated. In embodiments when located and/or installed on the production facility, the pig launcher takes up a minimum of space.

Preferably, the apparatus is adapted to allow a pig train to be formed in the export tubing. Advantageously, the pig train may be formed in the export tubing while the production fluid flows through the bypass tubing.

Preferably, the apparatus is adapted to selectively direct production fluid flow through the export tubing, the pig launcher, and/or the bypass tubing. The apparatus may be adapted to switch between flow through the export tubing, the pig launcher, and/or the bypass tubing gradually and/or controllably. The apparatus may be adapted to provide a gradual and/or controllable build up of pressure and production fluid flow rate upon switching.

The apparatus may comprise at least one fluid flow valve for controlling the flow and/or pressure of production fluid in the pipeline. The at least one fluid flow valve may comprise at least one export tubing valve operable to prevent flow through the export tubing and/or at least one bypass tubing valve operable to prevent flow through the bypass tubing.

The apparatus may comprise at least one valve to allow pigs in the pig launcher to be exposed to fluid flow from the export tubing. Preferably, the at least one valve allows the pigs to be temporarily exposed to fluid flow to launch the pig into the export tubing. Preferably, the valve is located in an inlet to the pig launcher from the export tubing, said inlet located upstream of a fluid flow valve in the export tubing.

The production fluid may be a mixed phase fluid. The production fluid may comprise oil and/or gas hydrocarbons and water. The production fluid may be a corrosive fluid, and may be a raw and/or untreated fluid from the production well(s).

According to a second aspect of the invention, there is provided a method of launching a pig into a pipeline, the method comprising: exporting production fluid from a production well through export tubing; directing a flow of production fluid through bypass tubing to bypass a first location of the export tubing; and launching a pig into the export tubing at the first location.

Preferably, the method includes directing a flow of production fluid through bypass tubing to bypass a first length of the export tubing.

The method may comprise forming a pig train in the length of the export tubing. The method may comprise successively launching pigs into the export tubing to form the pig train. Successively launching pigs to form a pig train may be carried out while flow of production fluid is being directed through the bypass tubing.

The method may comprise directing the flow of production fluid to launch the pig or pig train into the export tubing.

The method may comprise switching between and/or controlling flow of production fluid through any one of the bypass tubing, the main tubing, and/or a pig launcher for launching pigs.

The method may comprise selectively switching the flow of production fluid to push a pig along the main tubing.

The method may comprise selectively switching the flow of production fluid through the bypass tubing for flow of fluid along the export tubing.

The method may comprise moving a first pig from the first location to a second location, downstream of the first, and launching a second pig into the export tubing at the first location. The method may comprise coupling first and second pigs to form a pig train.

Other methods may be defined according to corresponding features defined in the first aspect of the invention.

### BRIEF DESCRIPTION OF THE DRAWINGS

There will now be described by way of example only embodiments of the invention with reference to the following figures, of which:

FIG. 1 is a schematic representation of apparatus for launching a pig into a pipeline according to an embodiment of the invention; and

FIG. 2 is a schematic representation of apparatus for launching a pig into a pipeline according to an alternative embodiment of the invention.

### DETAILED DESCRIPTION

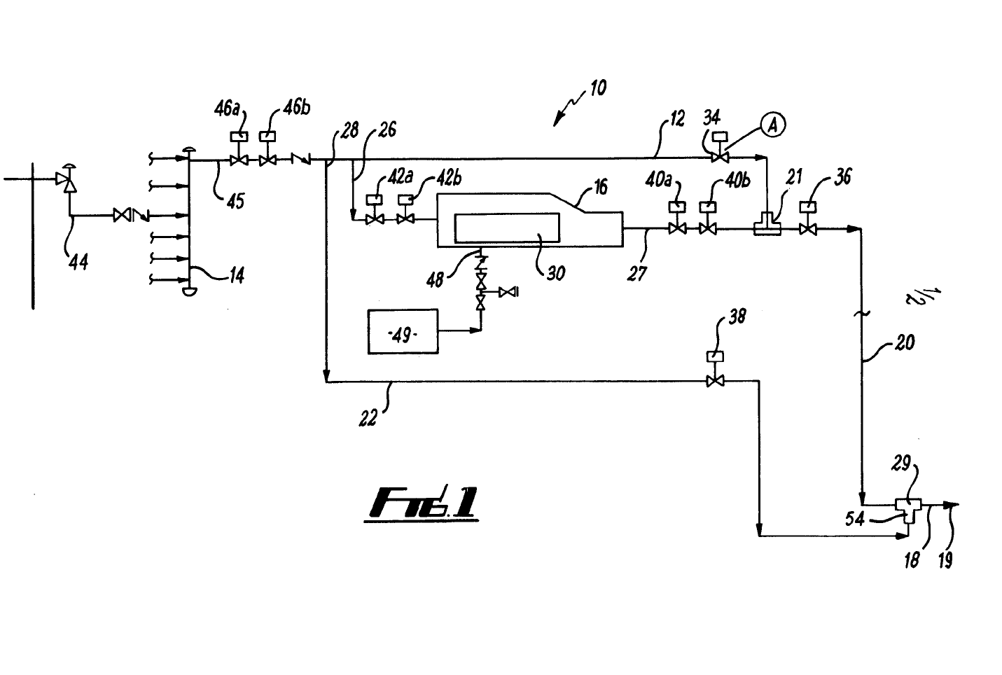

We refer firstly to FIG. 1, which generally shows apparatus for a production facility 10. The apparatus comprises a production manifold 14 through which production fluid from a sub-surface well is received before it is exported away downstream through a transport pipeline 18 according to arrow 19. In particular, the apparatus 10 assists with export of hydrocarbons from a production well during preparation and launch of pipeline inspection gauges (pigs) into the transport pipeline 18.

In the embodiment shown, the production manifold 14 is connected to the transport pipeline 18 via an intermediary pipe 12 and a main export riser 20, such that production fluid from the well can be transported away from the facility.

The apparatus 10 also comprises a pig launcher 16 to launch a pig into the pipeline. A first end of the pig launcher is connected to the intermediary tubing 12 via launcher inlet tubing 26, and a second end is connected to the main export riser 20 and intermediary tubing 12 at a pipe intersection 21 via outlet tubing 27. The inlet tubing 26 allows production fluid to be directed into the pig launcher 16 to push the pig 30 out and into the main export riser 20. The pig launcher 16 allows a pig 30 to be launched through the outlet tubing 27 into the main export riser 20.

In this example, the pig launcher 16 has an injection fluid inlet 48 to allow batches of corrosion inhibitor fluid to be injected from a treatment unit 49 to a pig 30 placed inside the launcher 16. Pigs 30 with corrosion inhibitor fluid may then be successively launched to form part of a pig train consisting of a number of individual pigs coupled together. The corrosion inhibitor is used to prevent corrosion of the pipeline 18 and riser 20 as may occur upon exposure to production fluid. Use of a train of pigs with batches of corrosion inhibitor fluid is particularly beneficial in long-distance pipelines, where a large volume of such fluid is required to sufficiently protect it from corrosion.

The apparatus 10 includes bypass tubing in the form of a second export riser 22 connected to the transport pipeline 18 at riser intersection 29 via a barred tee 54. Barred tee 54 allows fluid flow in all directions but prevents passage of a pig from either of the main export riser 20 or the transport pipeline 18 to the second export riser 22. The second export riser 22 is connected to the intermediary tubing 12 at its opposing end 28 upstream of the intersection of the intermediary tubing 12 and the pig launcher inlet tubing 26, and bypasses the main export riser 20, much of the intermediary tubing 12, and the pig launcher 16. This second export riser 22 provides a second path for flow of production fluid from the production manifold 14 and into the pipeline 18.

Optionally, a one-way check valve (not shown) may be provided upstream of the barred tee 54 on the second export riser to prevent flow of fluid into or along the second export riser 22 from the transport pipeline 18 or the main export riser 20.

The second export riser 22 bypasses a significant length of the main export riser 20, and allows a pig train to be received in the main export riser 20. The length bypassed by the second export riser can be selected according to the length of pig train required for the pigging operation in the pipeline. The second export riser 22 is formed from a corrosion resistant alloy, in contrast with the pipeline 18 and first export riser, which are formed from a lower-grade metal material. Consequently, the second export riser 22 does not need to be pigged and treated with corrosion inhibitor fluid.

The apparatus 10 is configured to selectively direct and control production fluid flow through the first or second export risers and/or the pig launcher in use. The intermediary tubing 12 is provided with intermediary tubing flow valve 34, the second and first export risers are provided with shutdown valves 38 and 36 respectively. Either side of the pig launcher 16, there are provided isolation flow valves 40a,b and 42a,b in the inlet and outlet tubing. The apparatus is further provided with safety valves 46a,b in the upstream section 45 together with a production choke valve 44 upstream of the production manifold 14. These valves are operated to switch or divert the flow of production fluid appropriately when a pigging operation is to be commenced and a pig is to be launched into the pipeline 18.

In use, the choke 44 and safety valves 46a,b are open, together with main export riser valves 36 and the intermediary tubing valve 34. The second export riser valve 38 is closed to fluid flow, and the downstream isolation valves 40a,b and upstream isolation valves 42a,b are closed preventing production fluid from passing into the pig launcher 16. Thus, production fluid is caused to flow along upstream section 45, the intermediary tubing 12, the main export riser 20 and into the pipeline 18.

When it is desired to launch a pig to deliver corrosion inhibitor in the transportation pipeline 18, the second export riser valve 38 is opened permitting flow through the second export riser, and then the intermediary tubing valve 34 is closed to prevent further flow through the intermediary tubing 12. The valves 42a,b remain closed, and thus production fluid is diverted to flow through the second export riser 22 and into the pipeline 18.

In this configuration, a pigging train can be located in the main export riser. In preparation for this, isolation valves 40a,b downstream of the pig launcher 16 are opened so that pigs 30 that are launched can move out of the launcher, through the open main riser valve 36, and into the export riser 20.

In the present example, the second export riser valve 38 is closed and the upstream launcher isolation valves 42a,b are opened exposing the pig launcher to fluid upstream. The production fluid is directed through the inlet tubing 26, pushing the pigs 30 fully into the export riser 20 past the main export riser valve 36 via the outlet tubing 27.

With the pig train successfully formed and located in the export riser, the intermediary tubing valve 34 is re-opened switching the flow back to the original route so that production fluid flows from the well through the intermediary piping 12, first export riser and the pipeline 18. The pig train is then pushed along the pipeline by the pressure force exerted by the production fluid flow. Corrosion inhibitor fluid is delivered by the pigs into the pipeline along its length, preventing pipeline corrosion being caused by the presence of production fluid.

The isolation valves 42a,b and 40a,b are closed of T again to isolate the pig launcher 16 so that the launcher may be accessed safely without exposure to production fluid pressures, allowing the pig launcher to be prepared ready for further pigging operations.

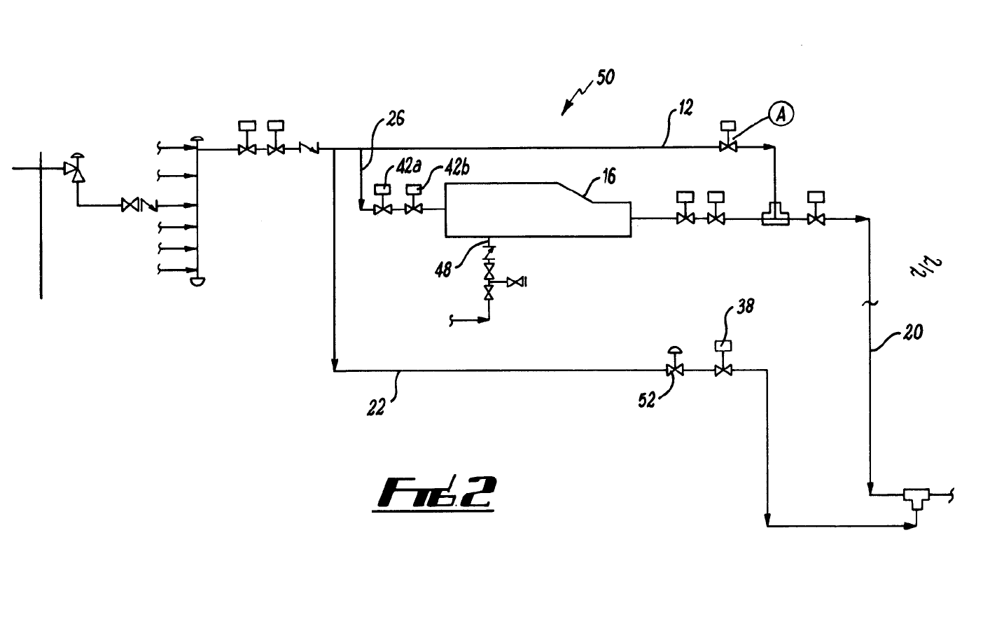

FIG. 2 shows an alternative embodiment, sharing many components with the embodiment of FIG. 1 but differing in that the second export riser 22 is provided with an additional flow restricting valve 52 located immediately upstream of the second riser valve 38.

In this case, flow is switched from flowing through the second export riser 22 (after preparation of pigs 30) to flow through the pig launcher 16 (with valves 42a,b opened) by gradually closing the restricting valve 52. This creates a drop in differential pressure in the second export riser 22, and progressively more fluid is prevented from passing through the export riser 22 and into the inlet tubing 26 to the launcher to push the pig into the export riser 20. Eventually, the second export riser 22 is fully closed off to fluid flow by closure of the valve 52, and the pig is launched into the main export riser 20. Subsequently, valve 34 is opened and launcher isolation valves 42a,b and valve 38 are closed. In this way, flow is resumed through the intermediary tubing 12, main export riser and into the pipeline without stopping production from the well.

It will be appreciated that in alternative embodiments the flow restriction valve 52 may be located in other locations between the pig launcher 16, and the second riser valve 38, including at locations on the inlet tubing 26 to the pig launcher.

In certain embodiments, the apparatus is installed on a hydrocarbon production facility with first and second export risers connecting to a pipeline for the export of hydrocarbon fluid from the production facility to shore.

It will be appreciated that in various embodiments the pigs 30 may be provided with other equipment, for example, cleaning elements to remove residue from pipeline interior surfaces.

In particular embodiments, the pig launcher 16 may be installed on an offshore production rig, and may be sized to occupy a minimum amount of space.

The present apparatus provides a number of benefits. Primarily, it functions to permit pig trains of substantial length to be built up, in the main export riser, and launched into a pipeline while minimizing or eliminating any need to cease production from the well. In certain embodiments, production does not need to cease at all. Accordingly, well fluids can be retrieved and exported more efficiently.

In addition, as the pig train is built up in the main export riser, the pig launcher can be relatively small in size, lending itself to installation on a minimum footprint facility, such as a wellhead rig, where space is at a premium and low maintenance functionality is desired.

The present apparatus is suitable for protecting conventional long-distance pipelines formed from conventional metal materials, and which may be susceptible to corrosion in the presence of production fluids.

Various modifications and changes may be made within the scope of the invention herein described.

1. An apparatus for a hydrocarbon production facility the apparatus comprising:
export tubing configured to provide a first flow path for production fluid from a production well;
a pipeline inspection gauge (pig) launcher configured to launch a pig into the export tubing at a first location; and
bypass tubing configured to provide a second flow path for the production fluid which bypasses the export tubing at the first location.

2. The apparatus of claim 1 wherein the bypass tubing defines a bypassed length of the export tubing, and the bypassed length extends to include the first location.

3. The apparatus of claim 2 wherein the bypassed length extends over a distance sufficient to accommodate a volume of treatment fluid located in the export tubing.

4. The apparatus of claim 2 wherein the bypassed length is adapted to receive a pig train comprising a plurality of pigs.

5. The apparatus of claim 4 wherein the bypassed length extends a distance sufficient to receive a pig train equipped for treating a long-distance pipeline.

6. The apparatus of claim 1 wherein the bypassed length extends substantially between the hydrocarbon production facility and a transport pipeline.

7. The apparatus of claim 1 wherein the export tubing comprises a first export riser connecting an end of a transport pipeline with the hydrocarbon production facility.

8. The apparatus of claim 7 wherein the bypass tubing comprises a second export riser.

9. The apparatus of claim 1 wherein the bypass tubing is formed from a corrosion resistant material.

10. The apparatus of claim 1 wherein the pig launcher is adapted to allow successive launches of a plurality of pigs to form a pig train in the export tubing.

11. The apparatus of claim 10 wherein the pig launcher is sized to house a limited sub-set of the plurality of pigs forming the pig train at any one time.

12. The apparatus of claim 1 wherein the export tubing is adapted to allow a pig train to be formed inside while the production fluid flows through the bypass tubing.

13. The apparatus of claim 1, further comprising a valve adapted to selectively direct production fluid flow through at least one of the export tubing, the pig launcher, and the bypass tubing.

14. The apparatus of claim 1, further comprising a valve adapted to gradually switch flow through at least one of the export tubing, the pig launcher, and the bypass tubing.

15. The apparatus of claim 1, further comprising at least one fluid flow valve for controlling the flow of production fluid in the pipeline.

16. The apparatus of claim 1, further comprising at least one export tubing valve operable to prevent flow through the export tubing.

17. The apparatus of claim 1, further comprising at least one bypass tubing valve operable to prevent flow through the bypass tubing.

18. The apparatus of claim 1, further comprising at least one valve to allow pigs in the pig launcher to be exposed to fluid flow from the export tubing to launch the pigs into the export tubing.

19. A method of launching a pipeline inspection gauge (pig) into a pipeline, the method comprising:
exporting production fluid from a production well through export tubing;
directing a flow of production fluid through bypass tubing to bypass a first location of the export tubing; and
launching a pig into the export tubing at the first location.

20. The method of claim 19 wherein directing a flow of production fluid through bypass tubing to bypass a first location of the export tubing comprises directing a flow of production fluid through the bypass tubing to bypass a first length of the export tubing.

21. The method of claim 19 further comprising forming a pig train in a length of the export tubing.

22. The method of claim 21 further comprising successively launching pigs into the export tubing to form the pig train.

23. The method of claim 22 wherein successively launching pigs comprises successively launching pigs to form a pig train while flow of production fluid is being directed through the bypass tubing.

24. The method of claim 19 wherein directing a flow of production fluid comprises directing the flow of production fluid to launch the pig or pig train into the export tubing.

25. The method of claim 19 wherein directing a flow of production fluid comprises switching flow of production fluid through at least one of the bypass tubing, the main tubing, and the pig launcher.

26. The method of claim 19 wherein directing a flow of production fluid comprises selectively switching the flow of production fluid to propel a pig along the export tubing.

27. The method of claim 19 further comprising moving a first pig from the first location to a second location, downstream of the first location, and launching a second pig into the export tubing at the first location.

28. The method of claim 27 further comprising forming a pig train from the first and second pigs.

29. (canceled)

30. An apparatus for a hydrocarbon production facility, the apparatus comprising:
export tubing configured to provide a first flow path for production fluid from a production well;
a pig launching arrangement configured to prepare a pipeline inspection gauge (pig) train in a length of the export tubing;
assembly configured to equip the pig train with sufficient treatment fluid to allow a long-length treatment of a production fluid transport pipeline; and
bypass tubing configured to provide a second flow path for the production fluid which bypasses the length of the export tubing.

31. A method of launching a pipeline inspection gauge (pig) train for treatment of a production fluid transport pipeline, the method comprising:
exporting production fluid from a production well through export tubing;
directing a flow of production fluid through bypass tubing to bypass a length of the export tubing;
preparing a pig train comprising a plurality of pigs in the length of the export tubing;
equipping the pig train with sufficient treatment fluid to allow along-length treatment of the production fluid transport pipeline; and
launching the pig train into the pipeline to treat the production fluid transport pipeline using the treatment fluid.
